(19) United States
(12) Patent Application Publication
(10) Pub. No.: US 2022/0361694 A1
(43) Pub. Date: Nov. 17, 2022

(54) LID FOR DRINKING CONTAINER WITH DRINKING PASSAGE

(71) Applicant: CUMULO GROUP PTY LTD, East Melbourne, Victoria (AU)

(72) Inventors: Jamie FORSYTH, East Melbourne (AU); Brett CAPRON, Black Rock, Victoria 3193 (AU)

(73) Assignee: CUMULO GROUP PTY LTD, East Melbourne, Victoria (AU)

(21) Appl. No.: 17/624,350

(22) PCT Filed: Jun. 30, 2020
(86) PCT No.: PCT/AU2020/050679

§ 371 Date: Jan. 2, 2022

(30) Foreign Application Priority Data
Jul. 1, 2019 (AU) 2019902330

(51) Int. Cl. A47G 19/22

(52) U.S. Cl. CPC A47G 19/2272

(57) ABSTRACT

A lid (20) for a drinking container (10) has perimeter (21) shaped to form a friction seal with the drinking container (10) at an inner surface (15) of a top edge (10); an inwardly indented form (24,28, 40) forming a drinking passage with a top rim (24) adapted to engage during a drinking action with an upper lip of a drinker while a lower lip of the drinker engages an outer surface (17) below the top edge (12) of the drinking container (10). Also provided is a lid (20) with lid top surface (25,26) and a drinking passage emerging through the lid top surface or between the lid and a top edge of the drinking container; the drinking passage extending down into the drinking container forming a channel (40, 41, 42, 43) sealing against an inner surface (13) of a side of the drinking container.

### FIELD

The present invention relates to reusable and disposable drinking containers, in particular to a new improved lid for a drinking container containing an improved drinking passage.

### BACKGROUND

Reusable and disposable cups and other drinking contains are well known with lids to secure the contents from splashing and with drinking passages to allow drinking through the lid. Commonly available lids contain drinking passages comprising holes in the lid which allow the user to drink the contents of the drinking container without removing the lid. This can be an unpleasant experience as the user's sensitive upper and lower lips engage the lid material, which typically offers poor mouth feel experience, which also differs from drinking from a drinking container or glass. Further, the requirement of a hole in the lid limits the available choice of lid materials, where sustainability is a concern. Other types of prior art lids contain drinking passages which are difficult to engage fully with the mouth to prevent spillage as the drinking container is tipped during drinking.

There is therefore a need to provide a lid with an improved drinking passage to overcome one or more of the above-mentioned disadvantages of the prior art, or to provide an alternative with additional features as described herein.

### SUMMARY OF THE INVENTION

In accordance with a first broad aspect of the invention there is provided a lid adapted to be fitted to a drinking container; the lid comprising:
a lid top surface bounded by a perimeter, the perimeter shaped to form a friction seal engaging substantially around its extent with the drinking container at an inner surface of a top edge of the drinking container;
an inwardly indented form extending from the perimeter adapted to form a gap in the engagement of the perimeter with the drinking container to provide a drinking passage between the inner surface below the top edge of the drinking container and an inner surface of the inwardly indented form; and
a top rim on the inwardly indented form adapted to engage during a drinking action with an upper lip of a drinker while a lower lip of the drinker engages an outer surface below the top edge of the drinking container.

In one embodiment, the perimeter further comprises a vertically tending surface having one or more ribs adapted to engage with the inner surface below the top edge of the drinking container to provide at least some of the friction seal.

In one embodiment, the lid further comprises a lip adapted to engage and cover the top edge of the drinking container away from the inwardly indented form.

In one embodiment, the inner surface of the inwardly indented form provides an upwards tapering surface terminating at the top rim.

In one embodiment, the inwardly indented form is shaped to extend down into the drinking container forming a channel sealing against an inner surface of a side of the drinking container so as to form a drinking straw to enable sucking of liquid from the drinking container.

In accordance with a second broad aspect of the invention there is provided a lid adapted to be fitted to a drinking container; the lid comprising:
a lid top surface bounded by a perimeter, the perimeter shaped to form a friction seal engaging substantially around its extent with the drinking container at an inner surface of a top edge of the drinking container;
a drinking passage emerging through the lid top surface or between the lid and a top edge of the drinking container;
the drinking passage extending down into the drinking container forming a channel sealing against an inner surface of a side of the drinking container so as to form a drinking straw to enable sucking of liquid from the drinking container.

### BRIEF DESCRIPTION OF DRAWINGS

FIG. 1 is a perspective view of a lid in accordance with an embodiment of the invention, constructed from silicone, installed on a cup;

FIG. 2 is a vertical cut through view of the lid and cup of FIG. 1;

FIG. 3 is an upper perspective view of the lid of FIG. 1;

FIG. 4 is a lower perspective view of the lid of FIG. 1;

FIG. 5 is a sketch of a lid in accordance with another embodiment of the invention incorporating a straw arrangement for drawing up liquid by sucking.

FIG. 6 is a vertical cut through view of the lid of FIG. 5 and associated drinking container; and

FIG. 7 is a perspective view of another embodiment similar to FIG. 1 constructed from bagasse.

### DETAILED DESCRIPTION OF EMBODIMENTS

Embodiments of the current invention will now be described.

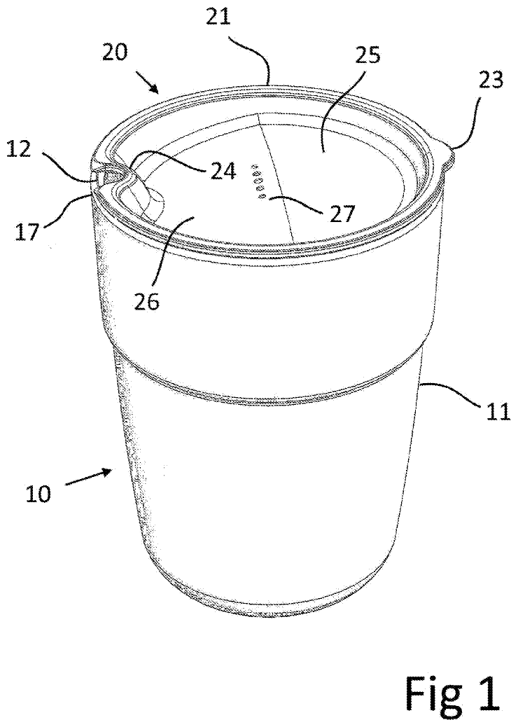

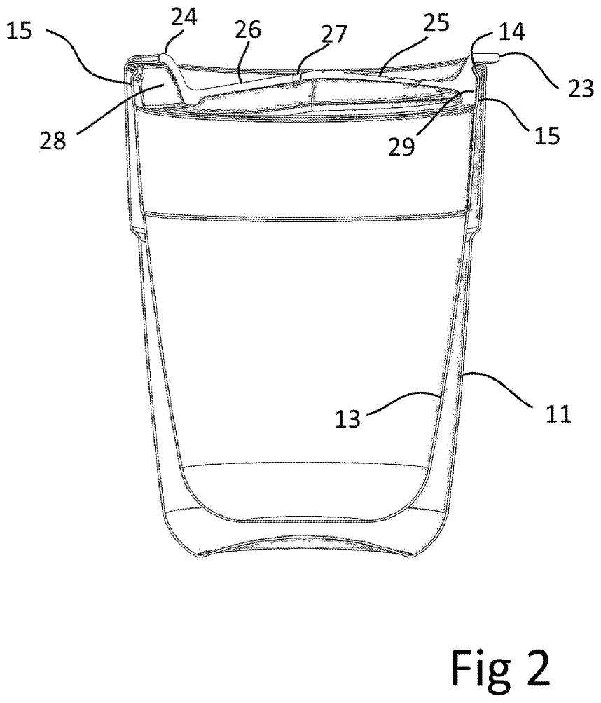

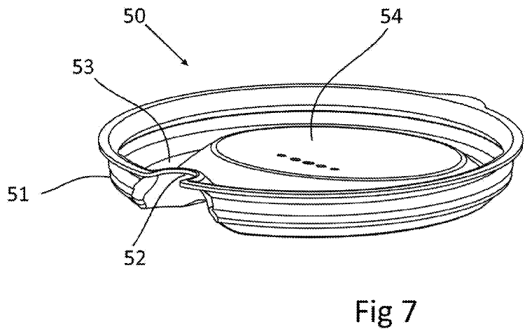

Referring first to FIGS. 1 and 2, lid 20 of an embodiment of the invention is shown installed onto cup 10. Cup 10 may be a disposable or reusable cup, composed of glass, plastic, steel, aluminium, cardboard or pulp-based material or any other suitable disposable or reusable material. Lid 20 may also be disposable or reusable. The particular design in FIG. 1 was constructed in silicone. A disposable version of lid 20 could be constructed from sugarcane bagasse, an example of which is shown in FIG. 7, but could also be moulded from disposable polymer sheet, including biodegradable materials or other lightweight material. A reusable version of lid 20 shown in FIG. 1 may be constructed from silicone, injection moulded polymers, including biopolymers or pressed metal, or any other suitable material.

Lid 20 comprises a lid top surface 25, 26 bounded by a perimeter 21 shaped to form a friction seal engaging substantially around its extent through a vertically tending surface 29 with the cup 10 at an inner surface 15 of a top edge of the cup 10. An inwardly indented form 24,28 extending inwardly from the perimeter 21 forms a gap in the engagement of the perimeter 21 with the cup 10 to provide a drinking passage between the inner surface 15 of the top edge of the cup and an inner surface 28 of the inwardly indented form 24.

A top rim 24 on the inwardly indented form is adapted to engage during a drinking action with an upper lip of a drinker, being disposed at a similar level to the top edge 12 of cup 10 and meeting top edge 12 where indented form 24 begins extending from perimeter 21, while a lower lip of the drinker engages an outer surface 17 of the top edge of the cup 10 below the top edge 12. This provides a more pleasant mouth feel with the smooth or firm surface of cup 10 engaging the lower lip as is a familiar sensation when drinking without a lid. The combined aperture formed by the top edge 12 of the cup 10 and top rim 24 on the inwardly indented form also enables the drinker to easily seal the drinking passage against leakage as the beverage is tipped.

Referring to FIGS. 2 and 4, a lip 32 is adapted to engage and cover the top edge 14 of the cup 10 away from the inwardly indented form 24,28. Lip 32 assists in registering lid 20 in its fully engaged position with cup 10 preventing further downwards movement.

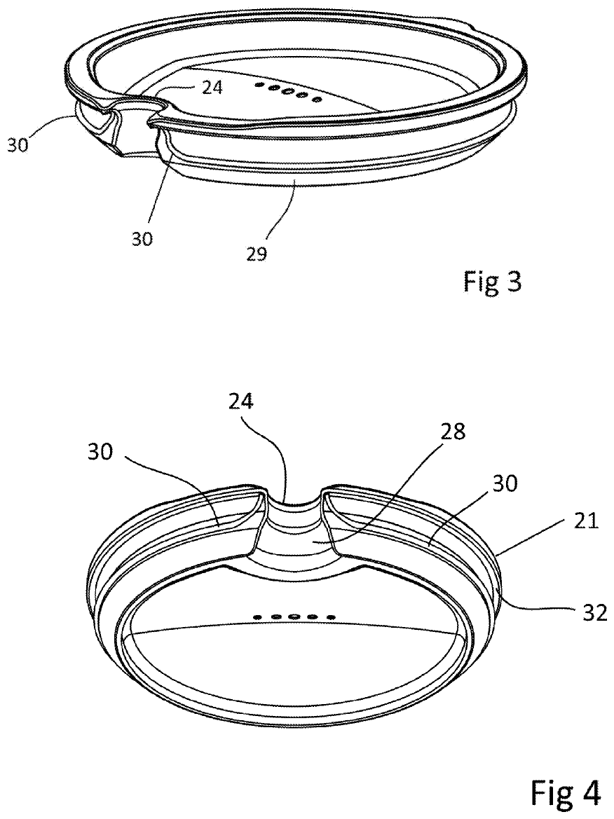

Referring to FIGS. 3 and 4, an inner surface 28 of inwardly indented form 24,28 provides an upward tapering surface terminating at the top rim 24 providing a smooth passage for egress of the beverage.

Air holes 27 as is known in the art are provided in the lid top surface 25, 26 to allow ingress of air and thereby continuing flow of liquid as the beverage contents are consumed.

Referring now to FIGS. 3 and 4, a further aspect of the friction seal is illustrated with rib 30 on the vertically tending surface 29 adapted to engage with the inner surface 15 below the top edge 12 of the cup. Rib 30 improves the functioning of the friction fit in terms of its opening, closing and sealing, compared with a flat surface. More than one rib may be provided in other embodiments.

Referring now to FIGS. 1-4, the top surface 25, 26 of cup 10 comprises a sloping part defined by a midline fold, sloping down to a bottom of the inwardly indented form. Opposite part 25 is slightly sloping down to a bottom of the perimeter 21 to a lesser extent on the other side. Together, the perimeter and the top surface 25, 26 form a dish shape which enables accumulation of any small quantity of liquid emerging through air holes 27 to be confined in the lid without spilling.

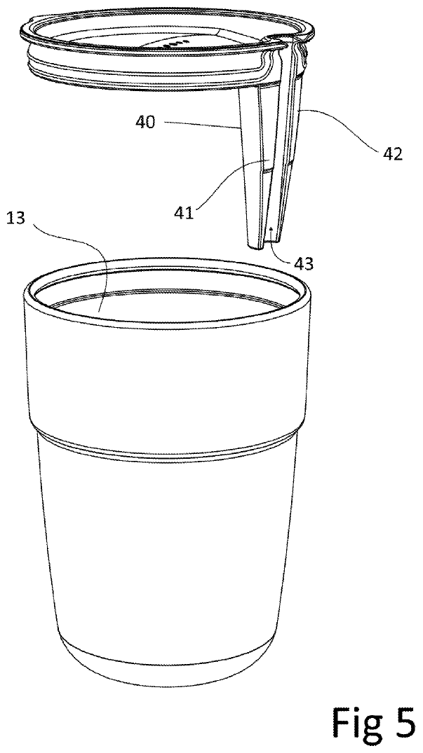

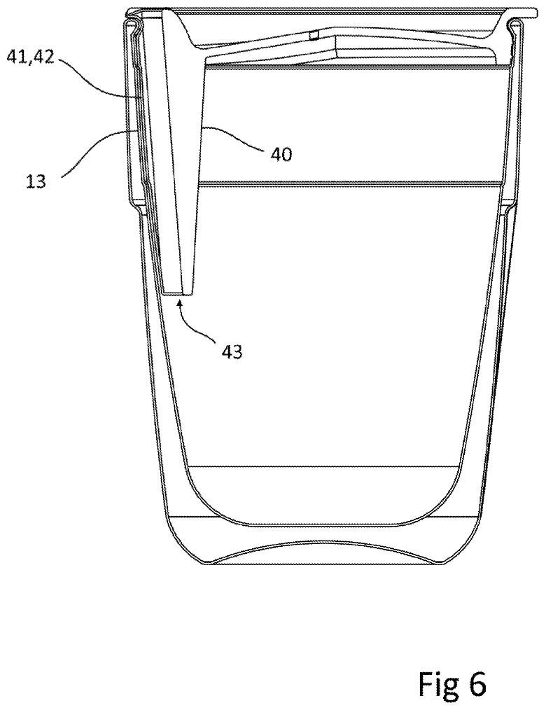

Referring now to FIGS. 5 and 6, another embodiment is based on the silicone embodiment of FIGS. 1-4 with the addition of an extension to the inwardly indented form defined by an open channel formed by extension piece 40 bounded by edges 41, 42. Edges 41, 42 engage in use and are shaped to correspond with an inner surface 13 of the side of the cup so as to form a functional drinking straw between extension piece 40 and inner surface 13 to enable sucking of the liquid from the cup in the direction of the arrow 43. This has a particular advantage of effectively providing an integral straw and lid. Also, because a channel is open, washing and sterilisation of the U-shaped channel of the lid is easy. This enables a reusable straw and lid system which can be easily thoroughly washed. It will be appreciated that the height, length and width of the functional straw can be varied depending on the nature of the contents to be drawn through.

Referring now to FIG. 7, a variant of the embodiment of FIGS. 1-4 is shown constructed from bagasse. Lid 50 is similar to lid 20 except for details of rib 51 near indented form 52 and top surface 53, 54 comprising a raised circular central plateau section 54 rising above an outer land 53, providing structural stability for that material.

Persons skilled in the art will also appreciate that many variations may be made to the invention without departing from the scope of the invention, which is determined from the broadest scope and claims.

For example, it will be appreciated that while the invention is exemplified in relation to a cup, it applies equally to other drinking containers such as glasses, mugs or tumblers.

It will also be understood that the second broad aspect of the invention (and corresponding claim 6) is expressed so as to not necessarily be restricted to to the drinking passage provided by the first broad aspect of the invention. While the functional drinking straw is exemplified with respect to the drinking passage between the top edge of the drinking container and the indented form of the first broad aspect of the invention, it may alternatively be provided in other embodiments of the 2^{nd} broad aspect of the invention through, for example, a hole of the conventional type in the lid top surface.

Further, the lid of either aspect of the invention may be augmented with an integrated closure mechanism, a removable spigot a tear-away tap or other similar mechanism to enable complete sealability for transport and storage.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any reference signs in the claims are used to assist in understanding embodiments only and are not intended to be limiting.

It is to be understood that, if any prior art publication is referred to herein, such reference does not constitute an admission that the publication forms a part of the common general knowledge in the art, in Australia or any other country.

1. A lid adapted to be fitted to a drinking container; the lid comprising:
a lid top surface bounded by a perimeter, the perimeter shaped to form a friction seal engaging substantially around its extent with the drinking container at an inner surface of a top edge of the drinking container;
an inwardly indented form extending from the perimeter adapted to form a gap in the friction seal to provide a drinking passage between the inner surface below the top edge of the drinking container and an inner surface of the inwardly indented form; and
a top rim on the inwardly indented form adapted to engage during a drinking action with an upper lip of a drinker while a lower lip of the drinker engages an outer surface below the top edge of the drinking container; and
wherein the inwardly indented form is shaped to extend down into the drinking container forming a channel sealing against an inner surface of a side of the drinking container so as to form a drinking straw to enable sucking of liquid from the drinking container.

2. The lid of claim 1, the perimeter further comprising a vertically tending surface having one or more ribs adapted to engage with the inner surface below the top edge of the drinking container to provide at least some of the friction seal.

3. The lid of claim 1, further comprising a lip adapted to engage and cover the top edge of the drinking container away from the inwardly indented form.

4. The lid of claim 1, wherein the inner surface of the inwardly indented form is configured to provide an upwards tapering surface terminating at the top rim.

5. (canceled)

6. (canceled)

7. The lid of claim 2, further comprising a lip adapted to engage and cover the top edge of the drinking container away from the inwardly indented form.

8. The lid of claim 2, wherein the inner surface of the inwardly indented form is configured to provide an upwards tapering surface terminating at the top rim.

9. The lid of claim 3, wherein the inner surface of the inwardly indented form is configured to provide an upwards tapering surface terminating at the top rim.
